(19) United States
(12) Patent Application Publication
(10) Pub. No.: US 2021/0042056 A1
(43) Pub. Date: Feb. 11, 2021

(54) DATA PROCESSING METHOD AND DEVICE

(71) Applicant: SZ DJI TECHNOLOGY CO., LTD., Shenzhen (CN)

(72) Inventors: Yong CONG, Shenzhen (CN); Dong QIN, Shenzhen (CN); Cheng HU, Shenzhen (CN)

(21) Appl. No.: 17/078,666

(22) Filed: Oct. 23, 2020

Related U.S. Application Data
(63) Continuation of application No. PCT/CN2018/084522, filed on Apr. 25, 2018.

(51) Int. Cl. G06F 3/06; G06F 9/30

(52) U.S. Cl. CPC G06F 3/0656; G06F 3/0659; G06F 3/0653; G06F 9/30127; G06F 3/0619; G06F 3/0673; G06F 3/064

(57) ABSTRACT

A data processing method includes obtaining N pieces of data at a time from data to be processed, determining first valid data from the N pieces of data, writing the first valid data into a storage device, and reading second valid data at a time from the storage device. N is an integer larger than or equal to 2. A number of pieces of data of the first valid data is larger than or equal to 0 and smaller than or equal to N. A number of pieces of data of the second valid data is K, and K is an integer larger than or equal to 1 and smaller than N.

### CROSS-REFERENCE TO RELATED APPLICATION

This application is a continuation of International Application No. PCT/CN2018/084522, filed Apr. 25, 2018, the entire content of which is incorporated herein by reference.

### TECHNICAL FIELD

The present disclosure relates to data processing and, more particularly, to a data processing method and device.

### BACKGROUND

At present, image signal processing can be applied to various electronic devices, such as smart phones, drones, etc. Some electronic devices, after shooting and obtaining an image, compress the image before saving it. When the image needs to be displayed to the user, the saved image is first decoded and then the decoded image is displayed. Therefore, decoding is an important part of image processing. In the process of image processing, a large amount of data is generated. Some data is valid data and some data is invalid data. The decoding process only needs to process the valid data, but does not need to process the invalid data. Therefore, in order to ensure the decoding efficiency, valid data needs to be filtered out from the data, and then the valid data is output for decoding processing.

At present, after data is obtained, it is determined in turn whether each pieces of data is valid data. If the data is valid data, the data is output for decoding processing, and if the data is invalid data, the data is not output for decoding processing. However, in the above method, if the data is determined to be invalid at the current time, the data will not be output for decoding. Therefore, the hardware of the decoding process at the current stage will be in a vacant state, which will cause a waste of resources and the efficiency of decoding processing is low.

### SUMMARY

In accordance with the disclosure, there is provided a data processing method including obtaining N pieces of data at a time from data to be processed, determining first valid data from the N pieces of data, writing the first valid data into a storage device, and reading second valid data at a time from the storage device. N is an integer larger than or equal to 2. A number of pieces of data of the first valid data is larger than or equal to 0 and smaller than or equal to N. A number of pieces of data of the second valid data is K, and K is an integer larger than or equal to 1 and smaller than N.

Also in accordance with the disclosure, there is provided a data processing device including a storage device, a window filter, and a controller in communication connection with the storage device and the window filter. The window filter is configured to obtain N pieces of data at a time from data to be processed, and determine first valid data from the N pieces of data. The controller is configured to write the first valid data into a storage device, and read second valid data at a time from the storage device. N is an integer larger than or equal to 2. A number of pieces of data of the first valid data is larger than or equal to 0 and smaller than or equal to N. A number of pieces of data of the second valid data is K, and K is an integer larger than or equal to 1 and smaller than N.

### BRIEF DESCRIPTION OF THE DRAWINGS

FIG. 1 is a schematic flow chart of a data processing method according to an example embodiment.

FIG. 2 is a schematic diagram illustrating the data processing method according to another example embodiment.

FIG. 3 is a schematic structural diagram of a data processing device according to an example embodiment.

FIG. 4 is a schematic structural diagram of a data processing device according to another example embodiment.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Solutions of embodiments of the present disclosure can be applied to image processing. Consistent with the disclosure, when a large amount of data is being processed, invalid data is filtered in advance and valid data is obtained, which will speed up the processing. In addition, the solutions of the present disclosure can also be applied to the fields of artificial intelligence (AI), audio processing, etc., for example, feature points search using AI, and for contours search using filters.

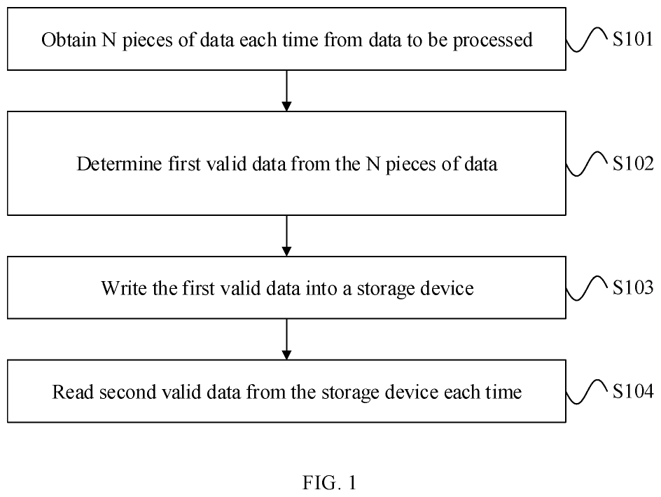

FIG. 1 is a flow chart of an example data processing method consistent with the disclosure. As shown in FIG. 1, at S101, N pieces of data are obtained each time from data to be processed (also referred to as “to-be-processed data”). N is an integer greater than or equal to 2. In this disclosure, a piece of data is also referred to as a “data piece.” In some embodiments, some data is acquired from the data to be processed through multiple data acquisitions, and the acquired data is used to perform the processes described below. Moreover, the number of pieces of data acquired each time can be the same, such as N, i.e., N pieces of data are acquired from the data to be processed each time. N is an integer greater than or equal to 2.

At S102, first valid data is determined from the N pieces of data. The first valid data is valid data among the N pieces of data, and the number of pieces of data in the first valid data is greater than or equal to 0 and smaller than or equal to N.

In some embodiments, the processes for acquiring the N pieces of data at different times are the same. For example, N pieces of data are acquired at a time, where the N pieces of data may include valid data and/or invalid data. All valid data determined from the N pieces of data can be referred to as “first valid data.” If the N pieces of data are all invalid data, then there is no first valid data. This scenario is also referred to as the number of pieces of data in the first valid data is 0. On the other hand, if the N pieces of data are all valid data, then the number of pieces of data in the first valid data is N.

In some embodiments, determining the first valid data from the N pieces of data (S102) may include, according to the relative order of the N pieces of data in the data to be processed, sequentially determining whether each of the N pieces of data is valid data to determine the first valid data.

In some embodiment, the relative order of the various pieces of data in the data to be processed can be obtained. Therefore, the relative order of the N pieces of data obtained from the to-be-processed data each time in the to-be-processed data is also certain. For example, each time four pieces of data can be obtained from the data to be processed, and the relative order of the four pieces of data obtained at a time in the data to be processed is: data A, data B, data C, data D. In this example, whether data A is valid data is first determined, then whether data B is valid data is determined, then whether data C is valid data is determined, and then whether data D is valid data is determined.

In some other embodiments, determining the first valid data from the N pieces of data (S102) may include simultaneously determining whether the N pieces of data are valid data to determine the first valid data. For example, each time four pieces of data can be obtained from the data to be processed, and the relative order of the four pieces of data obtained at a time in the data to be processed is: data A, data B, data C, data D. In this example, data A, data B, data C, and data D are simultaneously checked to determine whether they are valid data.

At S103, the first valid data is written into a storage device. In some embodiments, after the first valid data is determined from the N pieces of data, the first valid data is written into the storage device to buffer the first valid data. In some embodiments, the storage device can include a buffer.

At S104, second valid data is read from the storage device each time. The number of pieces of data in the second valid data is K, and K is an integer greater than or equal to 1 and smaller than N.

In some embodiments, data can be read from the storage device. In some embodiments, data can be read from the storage device multiple times. The number of pieces of data read from the storage device each time is the same. The data read from the storage device each time is collectively referred to as second valid data. The number of pieces of data in the second valid data is K, i.e., K pieces of data are read from the storage device each time, and K is greater than or equal to 1 and smaller than N. The number of pieces of data read from the storage device each time is the same, but the data content read from the storage device each time may be different.

That is, the storage device, e.g., a buffer, functions as a container for buffering the valid data filtered from the data to be processed each time. When the data is read, the data can be read from the storage device, and the number of pieces of data read from the storage device each time is smaller than the number of pieces of data obtained from the data to be processed each time. Thus, for most of the time, the storage device is buffered with data, and hence it can be ensured to the greatest extent that data can be read from the storage device every time.

In some embodiments, while N pieces of data are obtained from the data to be processed, K pieces of data are also read from the storage device.

According to the data processing method consistent with the disclosure, N pieces of data are obtained from the data to be processed each time, first valid data is determined from every N pieces of data, the first valid data is then written into a storage device, and K pieces of data are read from the storage device each time. N is an integer greater than or equal to 2, and K is an integer greater than or equal to 1 and smaller than N. Therefore, the probability that data is read from the storage device each time is increased, and the likelihood that the hardware for processing data read from the storage device is in a vacant state is reduced. As a result, the waste of resources is reduced, and the subsequent processing efficiency of reading data from the storage device is improved. For example, the efficiency of decoding process is improved.

In some embodiments, writing the first valid data into the storage device (S103) may include, according to the relative order of various pieces of data of the first valid data in the data to be processed, sequentially writing the various pieces of data of the first valid data into the storage device.

In some embodiment, the relative order of various pieces of data in the data to be processed can be obtained. Therefore, the relative order of the N pieces of data obtained from the to-be-processed data each time in the to-be-processed data is also certain. For example, N equals four, i.e., each time four pieces of data are obtained from the data to be processed, and the relative order of the four pieces of data obtained at a time in the data to be processed is: data A, data B, data C, data D. Thus, if the first valid data determined from the four pieces of data includes data A and data D, then the relative order of the various pieces of data of the first valid data in the data to be processed is: data A, data D. Then, when data A and data D are being written into the storage device, data A and data D are written into the storage device according to the relative order of data A and data D in the data to be processed, i.e., data A is written into the storage device first, then data D is written into the storage device.

In some embodiments, reading the second valid data from the storage device each time (S104) may include reading the second valid data from the storage device each time according to a preset rule. The preset rule can include that data written into the storage device earlier is read out earlier, and data written into the storage device later is read out later. In this disclosure, the data written into the storage device earlier is also referred to as “earlier-written data,” and the data written into the storage device later is also referred to as “later-written data.”

In some embodiments, each time the second valid data (that is, the K pieces of data) is read from the storage device, it is read according to a preset rule. In some embodiments, for each time of reading the second valid data from the storage device, the reading is performed according to a rule of first reading data written into the storage device earlier and then reading data written into the storage device later. That is, the K pieces of data among the buffered data that are written into the storage device first are read from the storage device first. After the K pieces of data are read from the storage device, the K pieces of data are deleted from the storage device. In general, the second valid data read from the storage device at an earlier time was written into the storage device earlier than the second valid data read from the storage device at a later time.

For example, data A is written into the storage device before data D. If K is equal to 1, i.e., one piece of data is read from the memory each time, then data A is first read from the storage device, and data D is read from the storage device later.

In some embodiments, the storage device can include a first-in, first-out (FIFO) storage device.

Consistent with the disclosure, the relative order of various pieces of data read from the storage device can be kept consistent with the relative order of the various pieces of data in the data to be processed.

In some embodiments, when the sum of the number of pieces of data in the first valid data and the number of pieces of data buffered in the storage device is smaller than or equal to the maximum number of pieces of data that can be buffered in the storage device, the above process at S103 is executed. This maximum number is also referred to as “maximum number of bufferable pieces of data,” and the data buffered in the storage device is also referred to as “buffered data.” In some embodiments, after the first valid data is determined from the N pieces of data, it is determined whether the sum of the number of pieces of data in the first valid data and the number of pieces of data buffered in the storage device is smaller than or equal to the maximum number of pieces of data that can be buffered by the storage device. If the sum of the number of pieces of data in the first valid data and the number of pieces of data buffered in the storage device is smaller than or equal to the maximum number of pieces of data that can be buffered in the storage device, it means that there is enough free space in the storage device to buffer the first valid data, and hence the first valid data is written into the storage device. If the sum of the number of pieces of data in the first valid data and the number of pieces of data buffered in the storage device is greater than the maximum number of pieces of data that can be buffered in the storage device, it means that there is no free space in the storage device for buffering the first valid data, and hence the first valid data is temporarily not written into to the storage device. In some embodiments, the above determination can be performed after the K pieces of data are read from the storage device. If the sum is still greater than the maximum number, then the above determination can be performed again after another K pieces of data are read from the storage device. The above wait and determination process can be repeated until the sum is smaller than or equal to the maximum number, at which time the first valid data can be written into the storage device.

In some embodiments, the maximum number of pieces of data that can be buffered by the storage device can be determined according to the number, N, of pieces of data obtained from the data to be processed each time and the number, K, of pieces of data read from the storage device each time. The maximum number of pieces of data that can be buffered in the storage device can be related to the values of N and K, so that sufficient free space in the storage device can be ensured, and hence the first valid data can be written into the storage device in time after the first valid data is determined from the N pieces of data.

In some embodiments, the maximum number of pieces of data that the storage device can buffer is greater than or equal to the sum of N and K. Thus, it can be ensured that when K pieces of data are read from the storage device and the N pieces of data obtained from the data to be processed are all valid data, the N pieces of data can be written into the storage device in time.

In some embodiments, the maximum number of pieces of data that the storage device can buffer is equal to 2 times N and minus K, i.e., 2×N−K. Thus, it can be ensured that if 2N pieces of data obtained from the data to be processed in two neighboring times are all valid data, the 2N pieces of valid data can be written into the storage device in time.

In some embodiments, when the number of pieces of data buffered in the storage device is greater than or equal to K, the second valid data (K pieces of data) is read from the storage device. Since it has been set to read K pieces of data from the storage device each time, when it is to read data from the storage device, whether the number of pieces of data buffered in the storage device is greater than or equal to K is first determined. If the number of pieces of data buffered in the storage device is greater than or equal to K, it means the amount of data buffered in the storage device is sufficient for reading, and then the K pieces of data can be read from the storage device. If the number of pieces of data buffered in the storage device is less than K, it means that the amount of data in the storage device is temporarily not sufficient for reading, and the data reading process is temporarily suspended. In some embodiments, the above determination can be performed after the first valid data is written into the storage device. If the number of pieces of data buffered in the storage device is still smaller than K, then the above determination can be performed again after other first valid data is written into the storage device. The above wait and determination process can be repeated until the number of pieces of data buffered in the storage device is greater than or equal to K, at which time the K pieces of data can be read from the storage device.

In some embodiments, after the first valid data is determined from the N pieces of data (S102), not only the first valid data is written into the storage device, but also data other than the first valid data among the N pieces of data is discarded. Since the data other than the first valid data among the N pieces of data acquired each time is invalid data, storage space and resources can be saved after the invalid data is discarded.

In some embodiments, 2N pieces of data acquired at two neighboring times are neighboring data in the data to be processed. For example, the data to be processed includes data A, data B, data C, data D, data E, data F, data G, data H, data I, data J, data K, etc. If data A, data B, data C, and data D are acquired from the data to be processed at a previous time, then data E, data F, data G, and data H are acquired at a next time, and so on.

In some embodiments, the value of N is preset, and the value of N is related to the data to be processed. Therefore, before the N pieces of data are obtained each time from the data to be processed (S101), the value of N is determined. In some embodiments, determining the value of N includes obtaining a proportion of valid data in the data to be processed, and determining the value of N according to the proportion and the value of K. For example, K is equal to 1, and the proportion of valid data in the data to be processed is ¼, which means that one piece of data in every four pieces of data is valid data, and one piece of data is read from the storage device each time. Thus, as long as each time four pieces of data are obtained from the data to be processed for determining whether they are valid data and the determined valid data is written into the storage device, it can be probabilistically guaranteed that each time one piece of data can be read from the storage device. As another example, K is equal to 2, and the proportion of valid data in the data to be processed is ¼, which means that one piece of data in every four pieces of data is valid data, and two pieces of data are read from the storage device each time. Thus, as long as each time eight pieces of data are obtained from the data to be processed for determining whether they are valid data and the determined valid data is written into the storage device, it can be ensured that each time two pieces of data can be read from the storage device.

In some embodiments, if the proportion is 1/M, then N is greater than or equal to T×K, where T is an integer greater than or equal to M and smaller than M+1. For example, if M is 3.5, then T is 4, or if M is 3, then T is 3. In some embodiments, the larger is the value of N, the greater is the probability that data can be read from the storage device each time.

In some embodiments, in order to ensure that the relative order of the data read from the storage device each time is consistent with the relative order in the data to be processed, the N pieces of data are N pieces of data that are sequential neighbors in the data to be processed. For example, the data to be processed includes data A, data B, data C, data D, data E, data F, data G, data H, data I, data J, data K, data L, etc. Then, the four pieces of data obtained from the data to be processed at various times are: data A, data B, data C, and data D; data E, data F, data G, and data H; data I, data J, data K, and data L; and so on.

In some embodiments, the number of pieces of data obtained from the data to be processed may be different at different times. For example, after the value of N is determined as described above, the number of pieces of data obtained from the data to be processed can be adjusted according to the actual application scenario and the value of N. For example, at the first time, N pieces of data are obtained from the data to be processed, but there is no valid data in the N pieces of data, then at the second time, N+X pieces of data can be obtained from the data to be processed, where X is an integer greater than 0. This can improve the probability that valid data exists in the data obtained at the second time from the data to be processed. The subsequent process of obtaining data from the data to be processed is similar and will not be repeated here.

In some other embodiments, the number of data obtained from the data to be processed may be different at different times. For example, after the value of N is determined as described above, more than N pieces of data can be obtained from the data to be processed in the first couple of times. For example, N+10 pieces of data can be obtained from the data to be processed at the first time, N+9 pieces of data can be obtained from the data to be processed at the second time, N+8 pieces of data can be obtained from the data to be processed at the third time, and so on. This can increase the probability that valid data exists in the data obtained from the data to be processed in the first couple of times, thereby increasing the probability of reading out data from the storage device at the beginning.

In some embodiments, a method consistent with the disclosure, such as one of the above-described example methods, may be implemented by software or may be implemented by a hardware circuit.

In some embodiments, the number N for the data obtained each time from the data to be processed is configured by a register. That is, after the value of N is determined through the above-described solutions, the value of N is registered in the register, and then N pieces of data are obtained from the data to be processed at each time according to the value of N stored in the register.

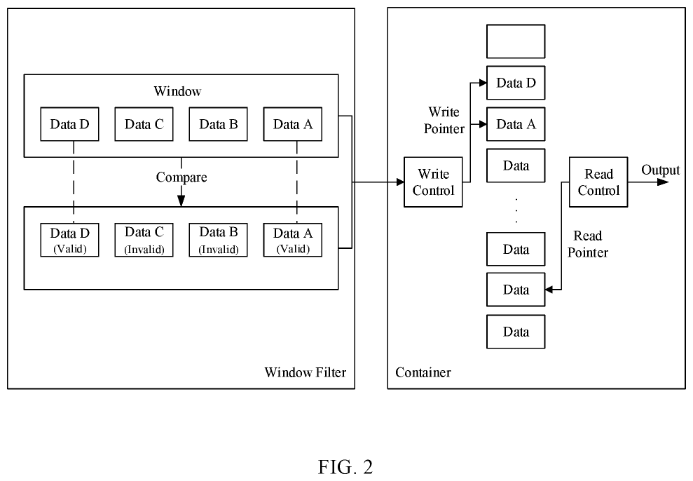

FIG. 2 is a schematic diagram illustrating an example data processing method consistent with the disclosure. A size of a sliding window in FIG. 2 is N, and N is set to 4. Each time the sliding window can obtain four pieces of data from the data to be processed, such as data A, data B, data C, and data D. Then it is determined whether each of these four pieces of data is valid data. For example, it is determined that data A is valid data, data B is invalid data, data C is invalid data, and data D is valid data. Then data A and data D, i.e., the valid data, are written into the storage device (also referred to as “container”). In addition, since the order of data A and data D in the data to be processed is that data A is before data D, data A can be first written into the storage device and then data D can be written, or data A and data D can be written at the same time but positions of data A and data B in the storage device are different. In some embodiments, the storage device is a FIFO storage device, and hence the data written first is read first and then the data written later is read. As shown in FIG. 2, data A is read before data D, to ensure that the reading order of the data is consistent with the order of the read data in the data to be processed. In addition, two pieces of data in the current sliding window is determined to be valid and written into the storage device, and one piece of data is read from the storage device each time, thus, even if all the data in the sliding windows is empty, i.e., all the data is invalid data, next time, there will still be data in the storage device available for reading.

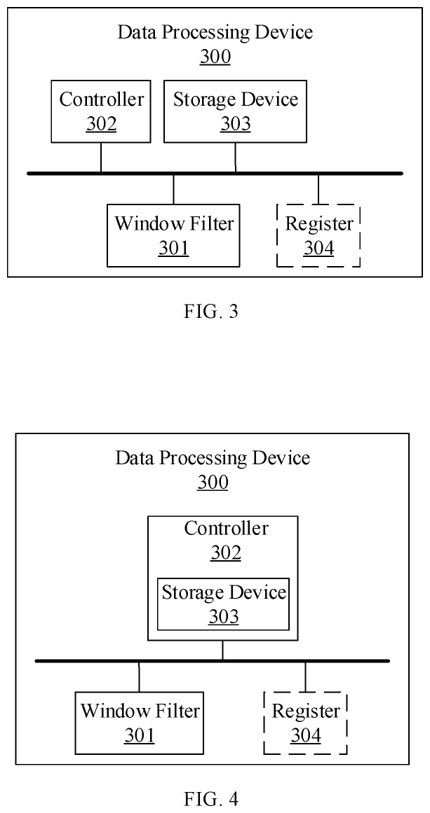

FIG. 3 is a schematic structural diagram of an example of a data processing device 300 consistent with the disclosure. As shown in FIG. 3, the data processing device 300 includes a window filter 301, a controller 302, and a storage device 303. The controller 302 is in communication connection with the window filter 301 and the storage device 303.

The window filter 301 is configured to obtain N pieces of data each time from data to be processed, where N is an integer greater than or equal to 2. The window filter 301 is further configured to determine first valid data from the N pieces of data, where the first valid data is valid data in the N pieces of data, and the number of pieces of data in the first valid data is greater than or equal to 0 and smaller than or equal to N.

The controller 302 is configured to write the first valid data into the storage device 303, and read second valid data from the storage device 303 each time. The number of pieces of data in the second valid data is K, where K is an integer greater than or equal to 1 and smaller than N.

The storage device 303 is configured to buffer the first valid data.

In some embodiments, the controller 302 is further configured to, according to a relative order of various pieces of data of the first valid data in the data to be processed, write the various pieces of data of the first valid data in sequence into the storage device 303.

In some embodiments, the controller 302 is further configured to read the second valid data from the storage device 303 each time according to a preset rule.

In some embodiments, the preset rule can include that data written into the storage device earlier is read out earlier, and data written into the storage device later is read out later.

In some embodiments, the controller 302 is further configured to, when the sum of the number of pieces of data in the first valid data and the number of pieces of data buffered in the storage device 303 is smaller than or equal to the maximum number of pieces of data that can be buffered in the storage device 303, write the first valid data into the storage device 303.

In some embodiments, the controller 302 is further configured to determine the maximum number of pieces of data that the storage device 303 can buffer according to the number, N, of pieces of data obtained from the data to be processed each time and the number, K, of pieces of data read from the storage device 303 each time. In some embodiments, determining the maximum number of pieces of data that can be buffered by the storage device 303 according to the number, N, of pieces of data obtained from the data to be processed each time and the number, K, of pieces of data read from the storage device 303 each time can be performed by another component other than the controller 302, such as a processor.

In some embodiments, the maximum number of pieces of data that the storage device 303 can buffer is greater than or equal to the sum of N and K.

In some embodiments, the controller 302 is further configured to, when the number of pieces of data buffered in the storage device 303 is greater than or equal to K, read the second valid data from the storage device 303.

In some embodiments, the window filter 301 is further configured to discard data other than the first valid data among the N pieces of data.

In some embodiments, the 2N pieces of data obtained at two neighboring times are neighboring data in the data to be processed.

In some embodiments, the controller 302 is further configured to obtain a proportion of valid data in the data to be processed, and determine the value of N according to the proportion and the value of K. In some embodiments, obtaining the proportion of valid data in the data to be processed and determining the value of N according to the proportion and the value of K can be performed by another component other than the controller 302, such as the processor.

In some embodiments, when the proportion is 1/M, N is greater than or equal to T×K, and T is an integer greater than or equal to M and smaller than M+1.

In some embodiments, the N pieces of data are N pieces of data neighboring to each other in the data to be processed.

In some embodiments, the window filter 301 is further configured to, according to a relative order of the N pieces of data in the data to be processed, sequentially determine whether each of the N pieces of data is valid data to determine the first valid data.

In some embodiments, the window filter 301 is further configured to simultaneously determine whether each of the N pieces of data is valid data to determine the first valid data.

In some embodiments, as shown in FIG. 3, the data processing device 300 further includes a register 304 configured to register the value of N. That is, the number N of the pieces of data obtained by the window filter 301 from the data to be processed each time is configured by the register 304.

In some embodiments, the storage device 303 is a FIFO storage device.

FIG. 4 is a schematic structural diagram of another example of the data processing device 300 consistent with the disclosure. The example shown in FIG. 4 differs from the example shown in FIG. 3 in that, in the example data processing device 300 shown in FIG. 3, the storage device 303 is a device independent of the controller 302, while in the example data processing device 300 shown in FIG. 4, the storage device 303 is a device embedded in the controller 302. In the example shown in FIG. 4, the storage device 303 can be, for example, a storage unit of the controller 302.

In some embodiments, the functions of the window filter 301 and the controller 302 described above can be implemented by a processor.

The data processing device of consistent with the disclosure can be used to perform a method consistent with the disclosure, such as one of the above-described example methods. The implementation principles and technical effects thereof are similar, and will not be repeated here.

Those of ordinary skill in the art will appreciate that the example elements and algorithm described above can be implemented wholly or partially by hardware, such as a processor, instructed by a program. The program can be stored in a non-transitory computer-readable storage medium and can include instructions that, when executed, cause a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. The technical solutions described in the foregoing embodiments can be modified, or some or all of the technical features can be equivalently replaced. When there is no conflict, the technical features of the disclosure can be combined. The modification, replacement, or combination does not cause the corresponding technical solution to deviate from the scope of the technical solutions of the embodiments of the disclosure. It is intended that the specification and examples be considered as example only and not to limit the scope of the disclosure, with a true scope and spirit of the invention being indicated by the following claims.

What is claimed is:

1. A data processing method comprising:
obtaining N pieces of data at a time from data to be processed, N being an integer larger than or equal to 2;
determining first valid data from the N pieces of data, a number of pieces of data of the first valid data being larger than or equal to 0 and smaller than or equal to N;
writing the first valid data into a storage device; and
reading second valid data at a time from the storage device, a number of pieces of data of the second valid data being K, and K being an integer larger than or equal to 1 and smaller than N.

2. The method of claim 1, wherein writing the first valid data into the storage device includes writing the pieces of data of the first valid data into the storage device according to a relative order of the pieces of data of the first valid data in the data to be processed.

3. The method of claim 1, wherein:
reading the second valid data from the storage device includes reading the second valid data from the storage device according to a preset rule; and
the preset rule includes reading earlier-written data earlier than later-written data.

4. The method of claim 1, wherein writing the first valid data into the storage device includes writing the first valid data into the storage device in response to determining that a sum of the number of pieces of data of the first valid data and a number of pieces of buffered data in the storage device is smaller than or equal to a maximum number of bufferable pieces of data of the storage device.

5. The method of claim 4, further comprising:
determining the maximum number of bufferable pieces of data according to N and K.

6. The method of claim 5, wherein the maximum number of bufferable pieces of data is greater than or equal to a sum of N and K.

7. The method of claim 1, wherein reading the second valid data from the storage device includes reading the second valid data from the storage device in response to determining that a number of pieces of data buffered in the storage device is greater than or equal to K.

8. The method of claim 1, further comprising:
discarding data of the N pieces of data other than the first valid data.

9. The method of claim 1,
wherein the N pieces of data are first N pieces of data obtained at a first time;
the method further comprising:
obtaining second N pieces of data at a second time from the data to be processed, the first time and the second time being neighboring to each other, and the first pieces of data and the second pieces of data being neighboring to each other in the data to be processed.

10. The method of claim 1, further comprising:
obtaining a proportion of valid data in the data to be processed; and
determining a value of N according to the proportion and a value of K.

11. The method of claim 1, wherein determining the first valid data from the N pieces of data includes:
according to a relative order of the N pieces of data in the data to be processed, sequentially determining whether the N pieces of data are valid to obtain the first valid data; or
simultaneously determining whether the N pieces of data are valid to obtain the first valid data.

12. The method of claim 1, wherein a value of N is configured by a register.

13. A data processing device comprising:
a storage device;
a window filter configured to:
obtain N pieces of data at a time from data to be processed, N being an integer larger than or equal to 2; and
determine first valid data from the N pieces of data, a number of pieces of data of the first valid data being larger than or equal to 0 and smaller than or equal to N; and
a controller in communication connection with the storage device and the window filter, the controller being configured to:
write the first valid data into the storage device; and
read second valid data at a time from the storage device, a number of pieces of data of the second valid data being K, and K being an integer larger than or equal to 1 and smaller than N.

14. The device of claim 13, wherein the controller is further configured to write the pieces of data of the first valid data into the storage device according to a relative order of the pieces of data of the first valid data in the data to be processed.

15. The device of claim 13, wherein:
the controller is further configured to read the second valid data from the storage device according to a preset rule; and
the preset rule includes reading earlier-written data earlier than later-written data.

16. The device of claim 13, wherein the controller is further configured to write the first valid data into the storage device in response to determining that a sum of the number of pieces of data of the first valid data and a number of pieces of buffered data in the storage device is smaller than or equal to a maximum number of bufferable pieces of data of the storage device.

17. The device of claim 16, wherein the controller is further configured to determine the maximum number of bufferable pieces of data according to N and K.

18. The device of claim 17, wherein the maximum number of bufferable pieces of data is greater than or equal to a sum of N and K.

19. The device of claim 13, wherein the controller is further configured to read the second valid data from the storage device in response to determining that a number of pieces of data buffered in the storage device is greater than or equal to K.

20. The device of claim 13, further comprising:
a register in communication connection with the window filter and configured to configure and register a value of N.
